(19) United States
(12) Patent Application Publication
(10) Pub. No.: US 2023/0262279 A1
(43) Pub. Date: Aug. 17, 2023

(54) METHOD AND SYSTEM FOR DELIVERING ON-DEMAND CONTENT VIA AN INTERACTIVE MEDIA PLATFORM

(71) Applicants: Craig Fogaros, N. Hutchinson Island, FL (US); Jobe Plevik, N. Hutchinson Island, FL (US)

(72) Inventors: Craig Fogaros, N. Hutchinson Island, FL (US); Jobe Plevik, N. Hutchinson Island, FL (US)

(21) Appl. No.: 18/109,264

(22) Filed: Feb. 14, 2023

Related U.S. Application Data
(60) Provisional application No. 63/310,555, filed on Feb. 15, 2022.

(51) Int. Cl. H04N 21/262; H04N 21/6332; H04N 21/41

(52) U.S. Cl. CPC H04N 21/262; H04N 21/6332; H04N 21/4126

(57) ABSTRACT

A method of delivering on-demand content via an interactive media platform is disclosed. A secure shell (SSH) connection from a host device to a target device is established. One or more scripts is issued on the target device by way of a command line. The script is executed to deliver content to the target device in response to a trigger event.

### CROSS-REFERENCE TO RELATED APPLICATIONS

This application claims priority to U.S. Provisional Application Ser. No. 63/310,555, filed Feb. 15, 2022, titled “METHOD AND SYSTEM FOR DELIVERING ON-DEMAND CONTENT VIA AN INTERACTIVE MEDIA PLATFORM”, hereby incorporated by reference in its entirety for all of its teachings.

### TECHNICAL FIELD

This invention relates to media delivery platforms. More specifically, this invention relates to delivering on-demand content via an interactive media platform that delivers the content to a target device in response to a trigger event.

### BACKGROUND OF THE INVENTION

Entertainment content is increasingly available in digital form for transmission to a variety of devices such as televisions, computers, and cellphones. Such content can be transmitted via a variety of systems to permit not only traditional broadcasting of the same content to a wide audience but also targeted transmission via streaming and downloads.

A typical content streaming system includes a media device such as a set-top box that receives media including, but not limited to video, audio, multimedia, etc., from a media source over a network. The media device provides the received media to an output device such as a television or a laptop computer. The media source may be a content developer or provider that provides media content over a wired and/or wireless network to the media device. Example media sources include Netflix, Hulu, Spotify and other applications that store content on a server or group of servers and stream movies and music over the Internet via push or pull commands or services.

According to Wikipedia, “push technology or server push is a style of Internet-based communication where the request for a given transaction is initiated by the publisher or central server” and “often based on information preferences expressed in advance . . . it is contrasted with pull/get, where the request for the transmission of information is initiated by the receiver or client.”

Platforms such as Netflix and Hulu provide only limited content within their servers. A subscriber to Netflix can only view content available from Netflix and not from any other source. The subscriber watching a Netflix science fiction action movie will receive recommendations to watch similar content available only on Netflix, not from whatever other content is available on other subscription or non-subscription services, cable, broadcast or on the Internet. Consumers also have no choice but to watch commercials, advertising or content shown by a particular service provider without the ability to receive alternative media during these “downtimes.” Media sources as Netflix, Hulu, TIVO, and other multimedia delivery providers lack the capability to change the content on the screen instantly to relevant content that a consumer prefers instead, based on instant feedback, artificial intelligence, and interactions between the consumer and the host provider in real-time.

Although these current services allow the delivery of content to a client that is either initiated by the user or made without waiting for the user to make a request, such services lack the two-way interactivity between host and end users—or server and clients—that allows any content to be sent from any provider, in real time and on-demand, to an end user device via an “always on” Internet connection. Accordingly, a need exists for a method and system which provides for such capabilities.

### SUMMARY OF THE INVENTION

In accordance with one embodiment of the present invention, a method of delivering on-demand content via an interactive media platform is disclosed. The method includes establishing a secure shell (SSH) connection from a host deice to a target device; and issuing one or more scripts on the target device by way of a command line. The script is executed to deliver content to the target device in response to a trigger event.

In some embodiments, the steps of establishing the shell connection and issuing commands involve gaining unrestricted access and control to the target device's operating system. It should be noted that the host device is capable, via the command line, to control any screen or display device that has an operating system, including but not limited to a set-top box, a computer, a television, a laptop screen, a tablet, a PDA, a PC monitor, an ATM display, or any other device, display, monitor or screen with an operating system.

In some embodiments, the one or more scripts is issued to deliver content to the target device in response to the trigger event without any user intervention.

The one or more scripts may be programmed to control the selection, timing, volume, applications, and/or operations of the target device.

In some embodiments, the trigger event is indicative of any deviation from an expected or existing operating device condition.

In certain embodiments, the trigger event is an automatic trigger including one or more of the following: any deviation from an expected or existing operating device condition, a change in channel; airing of a regularly scheduled commercial; dead airtime; changes to any “marker” such as to data stream or to the display output including but not limited to pixel data from a sample frame on the display. In response to the trigger event, new content is transmitted to the target device from the host device. The new content includes but is not limited to: commercials, advertisements, surveys, games, movies, shows, and coupons.

In certain embodiments, the trigger event is a manual trigger that is pre programmed by the host device to transmit content or data on the target device or on the target's mobile device.

The one or more scripts may be executed in response to a QR code (or bar code) that is displayed on the target device (or video display connected to the device) and scanned in by the target's mobile device. In one embodiment, the one or more scripts is executed in response to a QR code (or bar code) that is displayed on the target device (or video display connected to the device) and scanned in by the target's mobile device.

In some embodiments, the target device is a set-top box, and the QR or bar codes may be captured directly from the video display such as, but not limited to, a television screen, a laptop screen, a PC monitor, a digital camera, a PDA display, a liquid crystal display (LCD), a tablet, and an ATM display. The mobile device may be, but is not limited to, a smart phone. The host device may be, but is not limited to, a server such as a cloud server or web server, or a remote computer such as a laptop computer.

In one embodiment, the set-top box is an Android set-top box with pre-installed software including applications.

In another embodiment of the present invention, a system for delivering on-demand content via an interactive media platform is disclosed. The system includes a secure shell (SSH) access to establish a connection from a host device to a target device; and one or more scripts issued on the target device by way of a command line. The script is executed to deliver content to the target device in response to a trigger event.

In yet another embodiment of the present invention, a method of delivering on-demand content via an interactive media platform is disclosed. The method includes establishing a secure shell (SSH) connection from a host device to a target device. The host device receives data obtained from a mobile device. The data received is configured to generate a change in content transmitted to the target device. The method also includes relaying the change in content to the target device based upon criteria created on or delivered by the host device.

In some embodiments, the step of relaying the change in content to the target device includes issuing one or more scripts on the target device by way of a command line.

In certain embodiments, the criteria for relaying the changed content to the target device is based upon a trigger event.

The data obtained from the mobile device include but is not limited to the following: device location including visited places and location history; items purchased; browsing history, content of social network posts, application installation status and any other information stored on, or associated with, the mobile device in present or future installed applications.

### BRIEF DESCRIPTION OF THE DRAWINGS

FIG. 1 is a block diagram of a system for delivering on-demand content via an interactive media platform, in accordance with one embodiment of the present invention.

FIG. 2 is a flowchart illustration method of delivering on-demand content via an interactive media platform, in accordance with one embodiment of the present invention.

FIG. 3 is a flowchart illustration of a method of delivering on-demand content via an interactive media platform, in accordance with one embodiment of the present invention.

FIG. 4 is a block diagram of a system for delivering on-demand content via an interactive media platform, in accordance with one embodiment of the present invention.

FIG. 5 is an illustration of a device that has a QR code displayed on the screen, in accordance with one embodiment of the present invention.

### DETAILED DESCRIPTION OF THE PREFERRED EMBODIMENTS

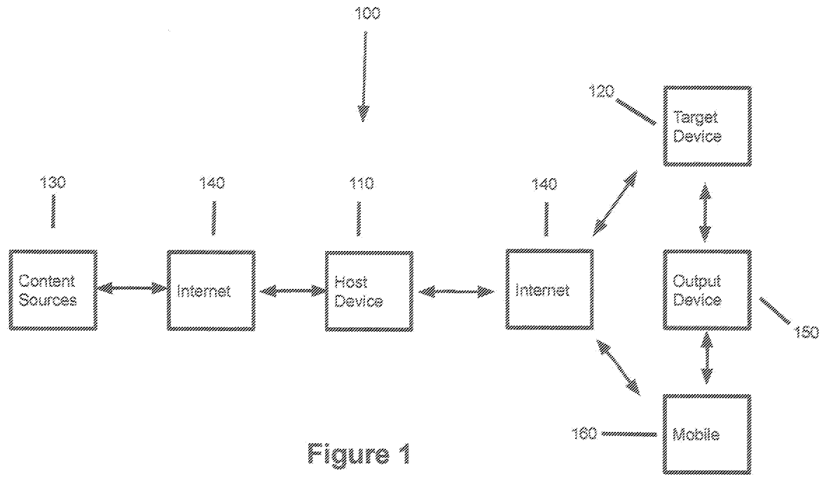

FIG. 1 shows a block diagram of a system 100 for delivering on-demand content via an interactive media platform, in accordance with one embodiment of the present invention. The system 100 includes a host device 110 which establishes a secure shell (SSH) connection with a target device 120. The SSH connection allows the host device 110 to issue one or more scripts on the target device 120 by way of a command line. The SSH supports scripting by gaining unrestricted access and taking control of operating system functions as well as various applications of the target device 110 through the operating system. For example, the SSH connection may be used to start, stop and operate applications as well as various commands, functions or services within the operating system.

The script (or scripts) is executed to deliver content from content sources 130 over a transmission control protocol over Internet Protocol (TCP/IP) network 140 to the target device 120 in response to a trigger event. In one embodiment, the script is executed by the host device 110 typing the script name on a command line, or the script may be included in another script, or some other mechanism may present the script for execution.

The host device 110 may be a server such as a cloud server or a web server, or a remote computer such as a laptop computer. The target device 120 may be a set-top box, laptop, or other device that is network enabled to receive content from any number of content sources 130. In an embodiment, the target device 120 may be part of and incorporated in an output device 150. For example, output device 150 may be a television and target device 120 may be a set-top box incorporated therein. Alternatively, the target device 120 may be a separate device from output device ISO. Content sources 130 may be a content developer or provider that provides media content over the Internet 140 to target device 120. For example, content source 130 may be an application that streams movies, shows, games, music, commercials, advertisements, and other content over the Internet.

In some embodiments, the script(s) is issued to deliver content to target device 120 in response to a trigger event without any user intervention. As an example, the script(s) may be programmed to control the selection, timing, volume, applications, and/or operations of the target device 120.

In some embodiments, the trigger event is indicative of any deviation from an expected or existing operating device condition. As one example, dead air-time on output device 150 may be a trigger event indicative of a deviation from an existing condition.

The trigger event can be an automatic trigger or a manual trigger. An automatic trigger, which may change content in real-time, includes but is not limited to: any deviation from an expected or existing operating device condition; a change in channel; airing of a regularly scheduled commercial; dead air-time; changes to any “marker” including as to data stream or to the display output including but not limited to pixel data from a sample frame on the display. In response to the trigger new event, new content may be transmitted to the target device 120 from the host device 110. The new content includes but is not limited to: commercials, advertisements, surveys, games, movies, shows, and coupons.

As one example of an automatic trigger event, a commercial break can be a trigger that causes the host device to execute a script that plays alternative content in place of the commercial or, alternatively, presents the user with a series of choices to view anything from cat videos to home movies instead of the regularly scheduled commercial.

As another example of automatic triggering, certain networks have their corporate logo appear on the bottom corner of the TV screen. During a commercial break in the program, the logo disappears. The disappearance of the logo can be a trigger to play content—initiated by the host device—rather than the regular scheduled commercial. As yet another example, the user changing to a different channel on the TV can trigger the host device to send new content. For example, the host device may send advertisements for food or food-related content to the screen when the user switches to the Food Network.

In contrast to automatic triggers, a manual trigger is pre-programmed by the host device 110 to transmit content or data on the target device 120 or on the target's mobile device. In one embodiment, the manual trigger may be predetermined and scheduled in advance without any deviation from an expected or existing operating condition of the target device. As one example, if the fast-food chain Wendy's requests a $20 gift certificate sent to users watching, say, channel 35 at 930 p.m., the host can issue a script to cause the gift card to pop up on target devices or users' cellphones at that time.

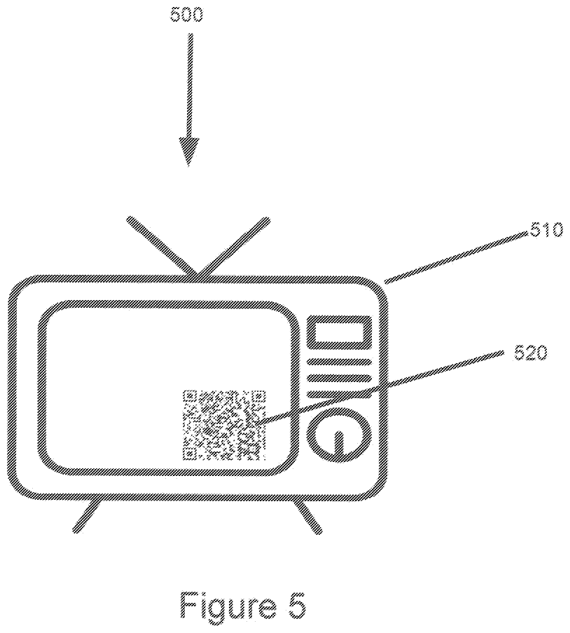

In some embodiments, the system 100 includes a mobile device 160 which may be any device configured to communicate with the host device 110 and the output 150. The mobile device 160 may be but is not limited to a smart phone. Using the mobile device 160, a user can change the content on the output device 150 by scanning a QR code or bar code appearing on the output device 150, which then prompts the host device 110 to issue a script command. As an example, if while watching TV, a QR code is floated on the screen, the user can scan the QR code with an iPhone that activates functions on the TV screen to receive a coupon from Pizza Hut on the user's iPhone or, alternatively, to download an app without having to visit the Appstore. As another example, the host device 100 sends a QR code to the output device via the target device. If the user sees the QR code that is published on the TV screen and scans it with a phone, as described further below in reference to FIG. 5, the content on the TV screen (or webpage on computer) can change and present new content on the TV screen.

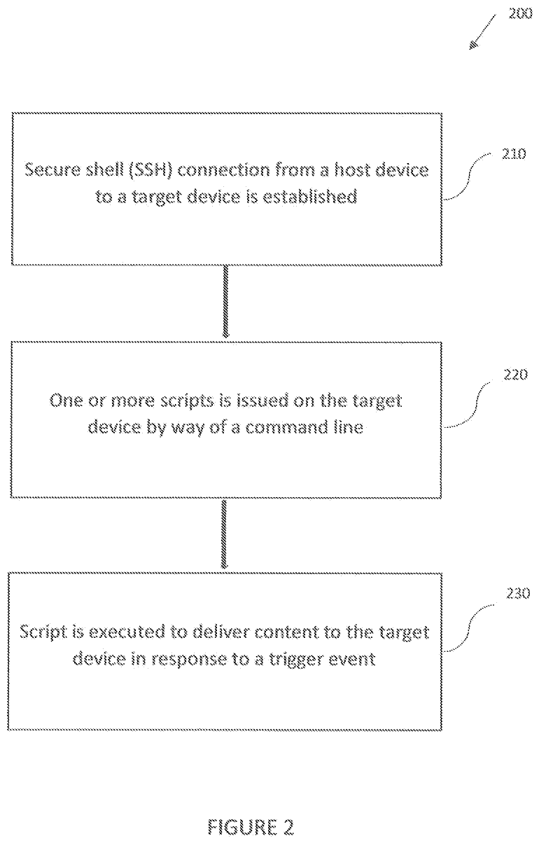

FIG. 2 is a flowchart 200 illustration of a method of delivering on-demand content via an interactive media platform. In 210, a secure shell (SSH) connection from a host device to a target device is formed. As one example in establishing the SSH connection, a Termux application may be pre-installed to a user's target device, such as a set top box, to allow shell access to appliance. This allows command line access wherein a continuous connection is established between the target device and the host device to directly connect to and control the target device. Next, in 220, one or more scripts is issued on the target device by way of a command line. As one example, the script may be executed by a host device programmer typing the script name on a command line. The script is executed to deliver content to the target device in response to a trigger event in 230. No user intervention is needed in the steps described in flowchart 200.

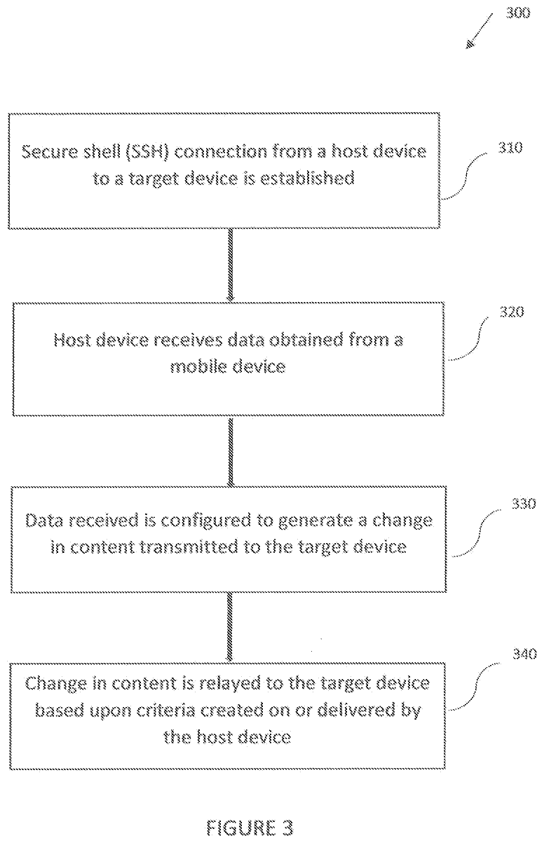

FIG. 3 is a flowchart 300 illustration of a method of delivering on-demand content via an interactive media platform. In 310, a secure shell (SSW connection from a host device to a target device is established. Next, in 320, host device receives data obtained from a mobile device. Data obtained from the mobile may include device location including places visited by the user and their location history; items purchased by the user; browsing history, content of social network posts, application installation status and any other information stored on, or associated with, the mobile device of user in present or future installed applications. Data received is configured to generate a change in content transmitted to the target device in 330. The change in content may include a change in channel on a TV screen or webpage on a computer. In 340, the change in content is relayed to the target device based upon criteria created on or delivered by the host device. The step of relaying the change in content to the subscriber target device may include issuing one or more scripts on the target device by way of a command line. The criteria for relaying the changed content to the target device is based upon a trigger event.

As an example of the embodiment of FIG. 3, a user with a mobile device may have visited In-N-Out Burgers for lunch. Location data on the user's mobile device would be accumulated and sent in real time to the host device who in turn may relay new content to the user's target device or mobile device, such as a $10 coupon for In-N-Out Burgers or a short video about outdoor grills.

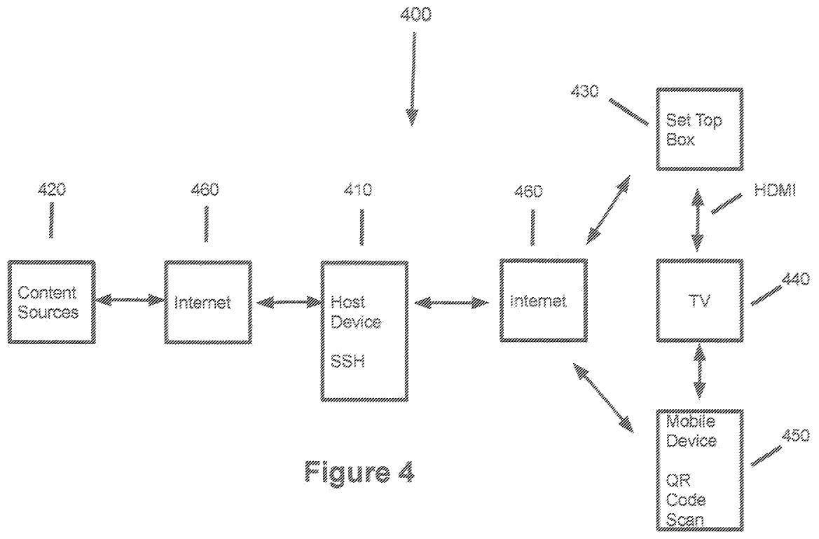

FIG. 4 shows a block diagram of a system 400, similar to the system 100 depicted in FIG. 1, for delivering on-demand content via an interactive media platform, in accordance with another embodiment of the present invention. The system includes a host device 410 which establishes a secure shell (SSH) connection with a set-top box 430. The SSH connection allows the host device 410 to issue one or more scripts on the set-top box 430 by way of a command line. The host device 410 may be a server or a laptop with an SSH server or client installed therein. In this embodiment, SSH access is pre-installed and allows “always on” connection and command line operation of the set-top box's operating system. The script (or scripts) is executed to deliver content from content sources 420 over a transmission control protocol over Internet Protocol (TCP/IP) network 460 to the set-top box 430 in response to a trigger event. In an embodiment, sc-top box 430 may be coupled to a television or TV 440 via an HDMI connection. The system includes a mobile device 450 configured to communicate with the host device 410 and equipped with a QR code reader to receive QR code scan and/or links from the host device 410. Using the mobile device 450, a riser can change the content on the TV 440 by scanning a QR code 520 or bar code (FIG. 5) appearing on the TV 510, as depicted in the device 500 of FIG. 5, which then prompts the host device 410 to send instructions to command line of the set-top box 430 to execute commands.

The following examples illustrate further embodiments for practicing aspects of the system and method of the present invention:

### Example 1

Replacing One Commercial with Another when Network Hug Fades Out.

The whole screen—or defined segments/snippets—of an output device (e.g., TV, laptop, desktop computer) is scanned for an identifiable item such as a station logo or hug. The identification of the logo or bug is used to activate a trigger or payload, either immediately or at a later time, on the target device. When the bug fades out, typically on the lower right side of the screen, new content is sent to the user.

### Example 2

Using an Identifiable Mark as a Trigger.

Similar to Example 1 directly above, an identifiable mark, such as a specific pixel in a specific part of the screen, is used to trigger the target device to run a script. The host device reads the marker (pixel) and activates certain actions that provide new content to the user. The activation process occurs when a certain pixel appears and when it disappears. Doing this would allow a national advertiser to put together an ad campaign that runs as normal on normal/broadcast/streamed TV but applies additional functionality on the system.

### Example 3

Automating Application Installations that Include Dialog Boxes.

The system can automate application installations that have dialog boxes which otherwise require user input. The host device logs the X and Y coordinates of the dialog box of a specific application and, by using the “always on” connection of the system, the system “pre-clicks” those dialog boxes once they are identified as being in frame. The host device sends command to the target device or display to simulate clicks. The system can program the process by dragging the scroll bar down, placing the cursor over “okay” box and handling the clicks for the user. This example removes barriers to entry typically associated with complex application installations or click-throughs.

### Example 4

Using a “Companion App” to Gather Data while User is Away from Target Device.

A user with a mobile smart phone is outside the home, away from the target device. The system collects data from the mobile phone and relays information to the target device after collecting the data. The host device would know when the user has arrived back near the target device, proximity-wise, due to Bluetooth connections established on the companion app with an opt-in.

### Example 5

Supplementing National Content with Localized Information.

The host device identifies what the user is currently watching and use c a section of the screen to add additional localized information. The localized information can either overlay on top of the other in a lower (or upper) section of the screen or shrink the primary teed down to provide the additional localized information.

### Example 6

Building a Programmatical List of Links to a Live Story of Interest.

The system via the host device scans feeds for live stories of interest and populates a list—such as a “local big events happening now” type list—allowing one click access to users, regardless of the app in which those live stories of interest are carried. For example, if a tornado is approaching or a building collapses, the story can be linked to the user's target device.

The present invention has been described in terms of specific embodiments incorporating details to facilitate the understanding of the principles of construction and operation of the invention. As such, references heron to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A method of delivering on-demand content via an interactive media platform comprising:
a. establishing a secure shell (SSH) connection from a host device to a target device; and
b. issuing one or more scripts on the target device by way of a command line;
wherein the script is executed to deliver content to the target device in response to a trigger event,
wherein the one or more scripts is issued to deliver content to the target device in response to the trigger event without any user intervention.

2. The method of claim 1 wherein the steps of establishing the shell connection and issuing commands involve gaining unrestricted access and control of the target device's operating system.

3. The method of claim 1 wherein the one or more scripts is programmed to control the selection, timing, volume, applications, and operations of the target device.

4. The method of claim 1 wherein the trigger event is indicative of any deviation from an expected or existing operating device condition.

5. The method of claim 1 wherein the trigger event is an automatic trigger including one or more of the following: any deviation from an expected or existing operating device condition, a change in channel; airing of a regularly scheduled commercial; dead airtime; changes to pixel data from a sample frame on the display.

6. The method of claim 5 wherein in response to the trigger event, new content is transmitted to the target device from the host device, and wherein the new content includes at least one of the fallowing: commercials, advertisement, surveys, games, movies, shows, and coupons.

7. The method of claim 1 wherein the trigger event is a manual trigger that is pre-programmed by the host device to transmit content or data on the target device.

8. The method of claim 7 wherein the one or more scripts is executed in response to a OR code that is displayed on the target device and scanned in by the user's mobile device.

9. The method of claim 8 wherein the QR codes is captured directly from the video display.

10. The method of claim 9 wherein the target device is a set-top box, the mobile device is a smart phone, the host device is a server or a laptop computer, and the video display is one of the following: a television screen, a laptop screen, a PC monitor, a digital camera, a PDA display, a liquid crystal display (LCD), a tablet, and an ATM display.

11. A system for delivering on-demand content via an interactive media platform comprising:
a. secure shell (SSH) access to establish a connection from a host device to a target device; and
b. one or more scripts issued on the target device by way of a command line;
wherein the script is executed to deliver content to the target device in response to a trigger event,
wherein the one or more scripts is issued to deliver content to the target device in response to the trigger event without any user intervention.

12. The system of claim 11 wherein the shell access connection and commands enable unrestricted access and control to the target device's operating system.

13. The system of claim 11 wherein the one or more scripts is programmed to control the selection, timing, volume, applications and operations of the target device.

14. The system of claim 11 wherein the trigger event is indicative of any deviation from an expected or existing operating device condition.

15. The system of claim 11 wherein the trigger event is an automatic trigger including one or more of the following: any deviation from an expected or existing operating device condition; a change in channel; airing of a regularly scheduled commercial; dead airtime; changes to pixel data from a sample frame on the display.

16. The system of claim 15 wherein in response to the trigger event, new content is transmitted to the target device from the host device, and wherein the new content includes at least one of the following: commercials, advertisements, surveys, games, movies, shows, and coupons.

17. The system of claim 11 wherein the trigger event is a manual trigger that is pre-programmed by the host device to transmit content or data on the target device.

18. The system of claim 11 wherein the one or more scripts is executed in response to a QR code that is displayed on the target device and scanned in by the user's mobile device.

19. A method of delivering on-demand content via an interactive media platform comprising:
a. establishing a secure shell (SSH) connection from a host device to a target device, wherein the host device receives data obtained from a mobile device, and the data received is configured to generate a change in content transmitted to the target device; and
b. relaying the change in content to the target device based upon criteria created on or delivered by the host device,
wherein the criteria for relaying the changed content to the target device is based upon a trigger event.

20. The method of claim 19 wherein the data obtained from the mobile device includes at least one of the following: device location; items purchased; browsing history; content of social network post; application installation status; and information stored on the mobile device in installed applications.
